(19) United States
(12) Patent Application Publication
(10) Pub. No.: US 2007/0268825 A1
(43) Pub. Date: Nov. 22, 2007

(54) Fine-grain fairness in a hierarchical switched system

(76) Inventors: Michael Corwin, Sunnyvale, CA (US); Joseph Chamdani, Santa Clara, CA (US); Stephen Trevitt, Gormley (CA)

Correspondence Address: HENSLEY KIM & HOLZER, LLC, 1660 LINCOLN STREET, SUITE 3000, DENVER, CO, 80264, US

(21) Appl. No.: 11/437,186

(22) Filed: May 19, 2006

(51) Int. Cl. H04L 12/26

(52) U.S. Cl. 370/230; 370/412

(57) ABSTRACT

A scalable solution to managing fairness in a congested hierarchical switched system is disclosed. The solution comprises a means for managing fairness during congestion in a hierarchical switched system comprising a first level arbitration system and a second level arbitration system of a stage. The first level arbitration system comprises a plurality of arbitration segments that arbitrate between information flows received from at least one ingress point based upon weights associated with those information flows (or the ingress points). Each arbitration segment determines an aggregate weight from each active ingress point providing the information flows to the segment and forwards a selected information flow along with the aggregate weight (in-band or out-of-band) to the second level arbitration system. The second level arbitration system then arbitrates between information flows received from the arbitration segments of the first level arbitration system based upon the aggregate weights received along with those information flows. The second level arbitration system then forwards a selected information flow to an egress point of the stage. The stage may, for example, comprise a portion of a switch, a switch, or a switch network.

### TECHNICAL FIELD

The invention relates generally to managing traffic flows in a hierarchical switched system and, more particularly, to managing fairness in a congested hierarchical switched system.

### BACKGROUND

A network, such as a local area network (LAN), a wide area network (WAN), or a storage area network (SAN), typically comprise a plurality of devices that may forward information to a target device via at least one shared communication link, path, or switch. Congestion may occur within the network when a total offered load (i.e., input) to a communications link, path, or switch exceeds the capacity of the shared communications link, path, or switch. During such congestion, design features of the link, path, switch, or network may result in unfair and/or undesirable allocation of resources available to one device or flow at the expense of another.

A SAN, for example, may be implemented as a high-speed, special purpose network that interconnects different kinds of data storage devices with associated data servers on behalf of a large network of users. Typically, a SAN includes high-performance switches as part of the overall network of computing resources for an enterprise. The SAN is usually clustered in close geographical proximity to other computing resources, such as mainframe computers, but may also extend to remote locations for backup and archival storage using wide area network carrier technologies.

The high-performance switches of a SAN comprise multiple ports and can direct traffic internally from a first port to a second port during operation. Typically, the ports are bi-directional and can operate as an input port for a flow received at the port for transmission through the switch and as an output port for a flow that is received at the port from within the switch for transmission away from the switch. As used herein, the terms “input port” and “output port,” where they are used in the context of a bi-directional switch, generally refer to an operation of the port with respect to a single direction of transmission. Thus, each port can usually operate as an input port to forward information to at least one other port of the switch operating as an output port for that information, and each port can also usually operate as an output port to receive information from at least one other port operating as an input port.

Where a single output port receives information from a plurality of ports operating as input ports, for example, the combined bandwidth of the information being offered to the switch at those ports for transmission to a designated port operating as an output port for that information may exceed the capacity of the switch and lead to congestion. Where the switches comprise a hierarchy of internal multiplexers, switches, and other circuit elements, such congestion may lead to an unfair and/or undesirable allocation of switch resources to a particular input flow versus another input flow.

A global scheduler that operates as a master arbiter for a switch has been used to deal with unfairness caused by the switching architecture during congested operation. Such a scheduler monitors all the input ports and output ports of the switch. The scheduler also controls a common multiplexer to prioritize switching operations across the switch and achieve a desired allocation of system resources. Since the scheduler monitors and controls every input and output of the switch, the scheduler is not scalable as the number of resources within the switch increases. Rather, as more and more components are added to a switch, the complexity of the scheduler increases exponentially and slows the response time of the switch.

### SUMMARY

The present invention offers a scalable solution to managing fairness in a congested hierarchical switched system. The solution comprises a means for managing fairness during congestion in a hierarchical switched system. As will be described in more detail below, the means for managing fairness comprises at least one first level arbitration system and a second level arbitration system of a stage. The first level arbitration system comprises a plurality of arbitration segments that arbitrate between information flows received from at least one ingress point based upon weights associated with the ingress points. Each arbitration segment determines an aggregate weight from each active ingress point providing the information flows to the segment and forwards a selected information flow along with the aggregate weight (in-band or out-of-band) to the second level arbitration system. The second level arbitration system then arbitrates between information flows received from the arbitration segments of the first level arbitration system based upon the aggregate weights received along with those information flows. The second level arbitration system then forwards a selected information flow to an egress point of the stage. The stage may, for example, comprise a portion of a switch, a switch, or a switch network.

The stage may also be scalable such that the second level arbitration system further aggregates the aggregate weights received from active arbitration segments of the first level arbitration system to determine a stage weight associated with the information flow forwarded to the egress point of the stage. This stage weight is then forwarded to an ingress point of a second stage disposed downstream of the stage. The second stage receives input information flows at a plurality of ingress points including the information flow received from the egress point of the prior stage. The second stage then uses the stage weight received along with the information flow of the prior stage to arbitrate between its information flow inputs as described above.

### BRIEF DESCRIPTIONS OF THE DRAWINGS

FIG. 1 illustrates an exemplary computing and storage framework including a local area network (LAN) and a storage area network (SAN).

FIG. 2 illustrates an exemplary stage comprising a means for managing fairness during congestion in a hierarchical switch system.

FIG. 3 illustrates another exemplary stage comprising a means for managing fairness during congestion in a hierarchical switch system.

FIG. 4 illustrates yet another exemplary stage comprising a means for managing fairness during congestion in a hierarchical switch system.

FIG. 4 illustrates another exemplary stage comprising a means for managing fairness during congestion in a hierarchical switch system.

### DETAILED DESCRIPTION

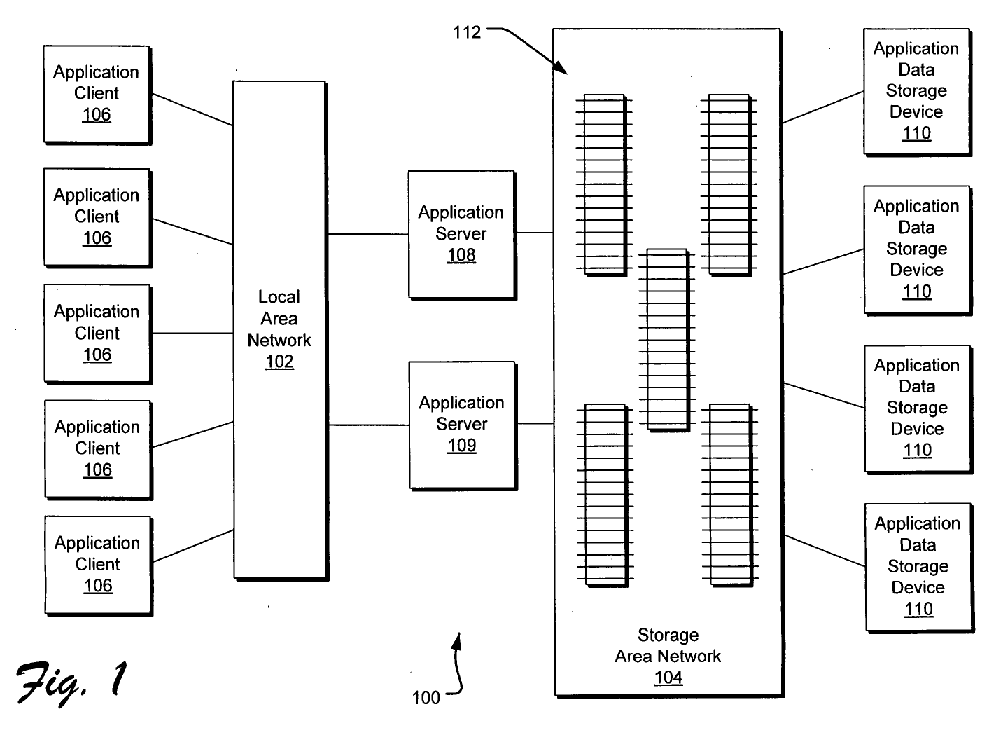

FIG. 1 illustrates an exemplary computing and storage framework 100 including a local area network (LAN) 102 and a storage area network (SAN) 104. Various application clients 106 are networked to application servers 108 and 109 via the LAN 102. Users can access applications resident on the application servers 108 and 109 through the application clients 106. The applications may depend on data (e.g., an email database) stored at one or more application data storage device 110. Accordingly, the SAN 104 provides connectivity between the application servers 108 and 109 and the application data storage devices 110 to allow the applications to access the data they need to operate. It should be understood that a wide area network (WAN) may also be included on either side of the application servers 108 and 109 (i.e., either combined with the LAN 102 or combined with the SAN 104).

Within the SAN 104, one or more switches 112 provide connectivity, routing, and other SAN functionality. Some of the switches 112 may be configured as a set of blade components inserted into a chassis or as rackable or stackable modules. The chassis, for example, may comprise a back plane or mid-plane into which the various blade components, such as switching blades and control processor blades, are inserted. Rackable or stackable modules may be interconnected using discrete connections, such as individual or bundled cabling.

In the illustration of FIG. 1, the LAN 102 and/or the SAN 104 comprise a means for managing fairness during congestion in a hierarchical switched system. As will be described in more detail below, the means for managing fairness comprises at least one a first level arbitration system and a second level arbitration system of a stage. The first level arbitration system comprises a plurality of arbitration segments that arbitrate between information flows received from at least one ingress point based upon weights associated with the ingress points. Each arbitration segment determines an aggregate weight from each active ingress point providing the information flows to the segment and forwards a selected information flow along with the aggregate weight (in-band or out-of-band) to the second level arbitration system.

The second level arbitration system then arbitrates between information flows received from the arbitration segments of the first level arbitration system based upon the aggregate weights received along with those information flows. The second level arbitration system then forwards a selected information flow to an egress point of the stage. The stage may, for example, comprise a portion of a switch, a switch, or a switch network. The stage may also be scalable such that the second level arbitration system further aggregates the aggregate weights received from active arbitration segments of the first level arbitration system to determine a stage weight associated with the information flow forwarded to the egress point of the stage. This stage weight is then forwarded to an ingress point of a second stage disposed downstream of the stage. The second stage receives input information flows at a plurality of ingress points including the information flow received from the egress point of the prior stage. The second stage then uses the stage weight received along with the information flow of the prior stage to arbitrate between its information flow inputs as described above.

The computing and storage framework 100 may further comprise a management client 114 coupled to the switches 112, such as via an Ethernet connection 116. The management client 114 may be an integral component of the SAN 104, or may be externally to the SAN 104. The management client 114 provides user control and monitoring of various aspects of the switch and attached devices, including without limitation, zoning, security, firmware, routing, addressing, etc. The management client 114 may identify at least one of the managed switches 112 using a domain ID, a World Wide Name (WWN), an IP address, a Fibre Channel address (FCID), a MAC address, or another identifier, or be directly attached (e.g., via a serial cable). The management client 114 therefore can send a management request directed to at least one switch 112, and the switch 112 will perform the requested management function. The management client 114 may alternatively be coupled to the switches 112 via one or more of the application clients 106, the LAN 102, one or more of the application servers 108 and 109, one or more of the application data storage devices 110, directly to at least one switch 112, such as via a serial interface, or via any other type of data connection.

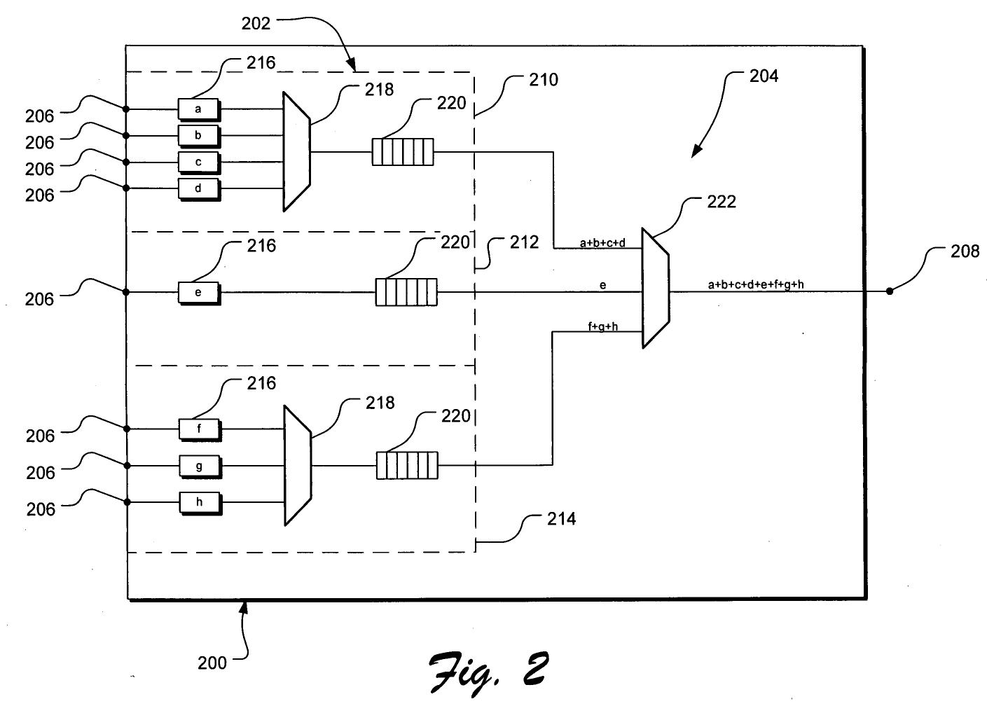

FIG. 2 illustrates a block diagram of a congestion-prone hierarchical stage 200 of the computing and storage framework and a means for managing fairness in that stage during congestion conditions. “Fairness” generally refers to allocating system resources between inputs or ingress points in a discriminating manner. For example, multiple ingress points (e.g., input ports of a switch) of the stage 200 may be allocated generally equal resources for passing information through the stage. Alternatively, one or more ingress points may be allocated greater or lesser resources, such as by weighting the individual ingress points. For example, low, medium, and high priority ports may be assigned or associated with different weights that ensure that the different priority ports have different relative priorities. A high priority port, for example, may be assigned or associated with a weight of ninety (90), a medium priority port may be assigned or associated with a weight of ten (10), and a low priority port may be assigned or associated with a weight of one (1). In such an example, a high priority port has a higher relative priority than a medium priority or a low priority port, and the medium priority port has a higher relative priority than a low priority port. Of course any number or combination of actual weights and/or priorities may be used to establish relative priorities within the stage 200.

The stage 200 of the computing and storage framework may comprise, for example, a portion of a LAN or a SAN. In the embodiment shown in FIG. 2, for example, the stage 200 may comprise a switch of a SAN, although the stage 200 may comprise a sub-set of the switch, a combination of multiple switches, the entire SAN, a sub-set of a LAN, or the entire LAN. The stage 200 may, for example, comprise any combination of communication links, paths, switches, multiplexers, or any other network components that route, transmit, or act upon data within a network.

The stage 200 comprises a dual-level fairness arbitration system in which each level comprises an independent arbiter. The independent arbiters of each stage, for example, may be used to approximate a global arbiter while only requiring a single direction of control communication (i.e., the system only requires feed-forward control communication, not feedback control communication although feedback control communication may also be used). The stage 200 comprises a first level arbitration system 202 and a second level arbitration system 204. For simplicity, only two levels of arbitration are shown, although the stage 200 may include any number of additional levels. The first level arbitration system 202 comprises a plurality of ingress points 206, such as input ports of a switch, ultimately providing a path through the second level arbitration system 204 to a common egress point 208, such as an output terminal of a switch. Although only a single egress point 208 is shown in the example of FIG. 2, the stage 200 may further comprise additional paths from at least one of the ingress points 206 (e.g., an input port of a switch) to at least one different egress point (e.g., an alternative output port of the switch).

Each ingress point 206 and egress point 208 receives and transmits any number of “flows.” Each flow, for example, may comprise a uniquely identifiable series of frames or packets that arrive at a specific ingress point 206 and depart from a specific egress point 208. Other aspects of a frame or packet may be used to further distinguish one flow from another and there can be many flows using the same ingress point 206 and egress point 208 pair. Each flow may thus be managed independently of other flows.

The first level arbitration system 202 comprises a plurality of segments 210, 212, and 214 that provide separate paths to the second level arbitration system 204 of the stage 200. At least one of these segments receives information flow inputs (e.g., packets or frames) from at least one ingress point 206, arbitrates between one or more of the inputs provided to the segment, and provides an output information flow corresponding to a selected one of the ingress points 206 to the second level arbitration system 204. Although the first and third segments 210 and 214 of the example shown in FIG. 2 arbitrate between information flows received from a plurality of ingress points 206, other segments of the first level arbitration system 204, such as the second segment 212, may merely pass an information flow from a single ingress point 206 to the second level arbitration system 204. The second level arbitration system 204, in turn, arbitrates between the information flows received from the various segments 210, 212, and 214 and forwards a selected information flow to the output terminal 208.

In the example shown in FIG. 2, each ingress point 206 has an assigned or associated weight. The assigned or associated weight may be static (e.g., permanently assigned to an ingress point 206 or virtual input queue 216) or may be dynamic (e.g., the weight may vary depending upon other conditions in the system).

As shown in FIG. 2, for example, the ingress points 206 of the first segment 210 have assigned weights of a, b, c, and d, respectively. The second segment 212 has a single ingress point 206 that has an assigned weight of e, and the third segment 214 has three ingress points 206 with assigned weights of f, g, and h, respectively. In one example, each of the weights may be equal (i.e., each of the ingress points has an equal relative priority ranking). In another example, the various ingress points may have different weights assigned to them. For example, one of the ingress points 206 may have a first assigned weight (e.g., 3) corresponding to a high priority ingress point, other ingress points may have a second assigned weight (e.g., 2) corresponding to an intermediate priority ingress point, and still other ingress points may have a third assigned weight (e.g., 1) corresponding to a low priority ingress point. In another example, each ingress point 206 may be assigned a weight received from an upstream stage (in-band or out-of-band) as described below. The system may arbitrate between various ingress points such that flows received at higher weighted ingress points have a higher relative priority than flows received at lower weighted ingress points. For example, an arbiter 218 of the segment 210 may allocate its available bandwidth to information flows received from a particular virtual input queue 216 of based on the ratio of its assigned weight to the total weight assigned to all of the virtual input queues 216 assigned to the arbiter 218.

In FIG. 2, for example, each of the plurality of ingress points 206 is coupled to an input of a virtual input queue 216 (e.g., a first-in, first-out (FIFO) queue). The virtual input queues 216 receive information flows (e.g., packets or frames) from the ingress points during operation of the stage and allow the arbiters 218 to arbitrate between the information flows received at different ingress points 206 targeting the same egress point 208. During congestion, for example, an information flow may be held by the virtual input queues 216 until the arbiter 218 corresponding to that queue has bandwidth available for the information flow. Once the arbiter 218 selects the flow, the arbiter forwards the flow to the corresponding virtual output queue 220 associated with that segment. The virtual output queues 220 receive these information flows and provide them to the second level arbitration system 204 for further arbitration by the arbiter 222.

The arbiters 218 may arbitrate among information flows received at their corresponding ingress points 206 targeting a single virtual output queue 220 (e.g., a FIFO queue) based upon the weights assigned to or otherwise associated with the ingress points 206, the virtual input queues 216, or a combination thereof. For example, the weights of the ingress points 206 may be used to determine a portion of the bandwidth or a portion of the total frames or packets available to the arbiter 218 that is allocated to information flows received from each ingress point 206. As shown in FIG. 2, for example, the arbiter 218 of the first segment 210 receives information flow inputs from four ingress points via corresponding virtual input queues 216. The inputs received from the first ingress point have an assigned weight of “a,” and the arbiter 218 may allocate the following ratio of its total bandwidth or total number of frames or packets to the first ingress point: a/(a+b+c+d). Inputs received at the second ingress point 206 would likewise receive a ratio of b/(a+b+c+d) of the arbiter's bandwidth or total number of frames or packets. Inputs received at the third ingress point would receive a ratio of c/(a+b+c+d) of the bandwidth or total number of frames or packets, and inputs received at the fourth ingress point would receive a ratio of d/(a+b+c+d). The arbiters 218 of the remaining segments 212 and 214 may also allocate their available bandwidth or total number of frames or packets between information flow inputs received at one or more of the ingress points associated with those segments. Other methods of biasing the arbiter according to weights are also known and can be incorporated.

The arbiters 218, alternatively, may utilize weighted round robin queuing to arbitrate between information flows in the virtual input queues 216 of the segments 210, 212, and 214 based upon the weights associated with the flows. The selected information flows are then forwarded to the second level arbitration system 204 for further arbitration. Alternatively, the arbiters 216 may bias their input information flows (e.g., bias their packet or frame grant) to achieve a weighted bandwidth allocation based upon the assigned weights of the ingress points or virtual input queues. In one configuration, for example, the arbiter may back pressure the ingress points 206 exceeding their portion of the bandwidth.

The weights associated with each of the ingress points 206, the virtual input queues 216, or the input flows of a particular segment 210, 212, or 214 are aggregated to provide an aggregate weight for information flows forwarded from that segment. The aggregate weight associated with an information flow is forwarded to the second level arbitration system 204 along with its associated information flow. The aggregate weight forwarded to the second level arbitration system 204 may be forwarded in-band with the information flow (e.g., within a control frame of the information flow) or may be forwarded in out-of-band with the information flow (e.g., along a separate control path).

The aggregate weight, for example, may comprise the total weight assigned to active ingress points 206 of the segment 210, 212, or 214. An active ingress point, for example, may be defined as an ingress port that has had at least one information flow (e.g., at least one packet or frame) received within a predetermined period of time (e.g., one millisecond prior to the current time) or may comprise an ingress point having at least one information flow (e.g., at least one packet or frame) within its corresponding virtual input queue 216 that is vying for resources of the stage 200 at the present time. Thus, assuming each ingress point 206 of the first segment 210 is active, the aggregated weight (a+b+c+d) of the first segment 210 is determined as the sum of the weights assigned to the ingress points 206 of the first segment 210 and is passed forward with an information flow from the first segment 210. If the second ingress point 206 of the first segment 210 (i.e., the ingress point assigned a weight of “b”) is inactive, however, the aggregated weight passed forward with an information flow at that time from the first segment 210 would be a+c+d. Where the weights of each ingress point 203 is equal (e.g., one), the aggregated weight determined for each segment corresponds to the number of active ingress points contributing to the segment at any particular point in time. The aggregated weight, however, may also be merely representative of such an algebraic sum and ratio. For example, the aggregate weight may be “compressed” so that fewer bits are required or levels (e.g., high, medium, and low) may be used to indicate two or more levels and indicate one or more threshold being met.

The second level arbitration system 204 receives information flows from the segments 210, 212, and 214, and arbitrates between these flows based on the aggregated weights received from the corresponding segments 210, 212, and 214. Assuming each ingress point 206 is active, the information flow received from the virtual output queue 220 of the first segment 210 has an aggregated weight associated with it of a+b+c+d (i.e., the sum of the weights of the four active ingress points of the first segment 210), the information flow received from the virtual output queue 220 of the second segment 212 has an aggregated weight associated with it of “e” (i.e., the weight associated with the active single ingress point of the second segment 212), and the information flow received from the virtual output queue 220 of the third segment 214 has an aggregated weight associated with it of f+g+h (i.e., the sum of the weights associated with the three active ingress points of the third segment 214). The arbiter 222 then arbitrates between the information flows based upon the aggregated weights associated with each of the information flows, such as described above with respect to the arbiters 218 of the first level arbitration system 202. The arbiter 222, for example, may utilize weighted round robin queuing to arbitrate between information flows in the virtual output queues 220 of the segments 210, 212, and 214 based upon the aggregated weights received from the segments. The mathematical algorithm used here, for example, may comprise the same algorithm described above with respect to the segments 210, 212, and 214. The selected one of the information flows is forwarded to the egress point 208 of the stage 200. Alternatively, the arbiter 222 may bias its selection of input information flows (e.g., bias their packet or frame grant for each input) to achieve a weighted bandwidth, frame, or packet allocation based upon their assigned aggregate weights. In one configuration, for example, the arbiter may back pressure the segments exceeding their portion of the bandwidth.

The arbitration system of the stage 200 further allows for scaling between multiple stages. Where at least one further stage is located downstream of the stage 200 shown, the arbiter 222 of the second level arbitration system 204 may aggregate the weights of the information flows received from the virtual output queues 220 of the segments 210, 212, and 214 to produce an aggregated weighting associated with the information flow forwarded to the egress point 208 of the stage 200. Thus, in the example shown in FIG. 2, assuming each input terminal is active, the weight associated with an information flow forwarded from the output terminal 208 of the stage 200 to another stage disposed downstream of the stage 200 is a+b+c+d+e+f+g+h. Thus, the arbitration scheme of the stage 200 is scalable by providing a weight to the next stage, which may assign that received weight to one of its ingress points.

Alternatively, such as where scaling multiple stages is not required, an information flow selected by the arbiter 220 may be forwarded to the egress point 208 of the stage 200 without a weight associated with it (or with the weight associated with the flow prior to arbitration by the arbiter 220).

The arbitration system of the stage 200 thus comprises dual levels of arbitration that only require a single direction of control communication (i.e., a feed-forward system) and does not require feedback control (although feedback control may be used). The system may further be variable to compensate for inactive ingress points and arbitrate upon the number of active ingress points competing for resources of the stage. Thus, as one or more ingress points become inactive, the arbiters 218 and 222 may immediately dedicate remaining bandwidth to other information flow inputs that are still active. Feedback loops changing upstream conditions, and causing corresponding delays, are unnecessary.

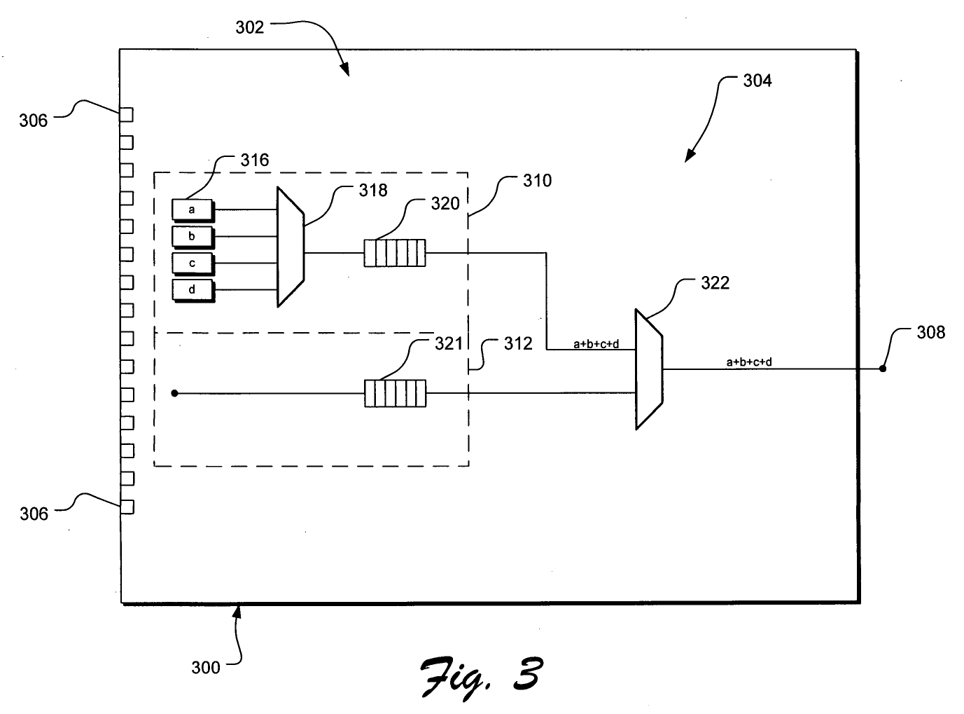

FIG. 3 shows another exemplary stage 300 of a hierarchical switch system. The stage 300, again, comprises a first level arbitration system 302 and a second level arbitration system 304, a plurality of ingress points 306 (e.g., input ports of a switch), and an egress point 308 (e.g., an output port of a switch). The first level arbitration system 304 comprises an allocated (i.e, fair) segment 310, and an unallocated segment 312.

The allocated segment 310 comprises at least one virtual input queue 316, an arbiter 318, and a virtual output queue 320. The virtual input queues 316 in this example, however, are not tied to a particular ingress point 306, but rather are shared between one or more ingress points providing a path to a common egress point 308. In one configuration, for example, a time division multiplexing (TDM) bus may be used to allow flows received at various ingress points 306 to be transmitted to a particular one of the virtual input queues 316 of the allocated segment 310 or to the unallocated segment 312. Other configurations, however, may also be used. In this manner, a particular stage may share virtual input queues 316 without the need to provide a virtual input queue 316 for every ingress point 306 and egress point 308 combination in the stage. Once an information flow input is received by one of the virtual input queues 316, the allocated segment operates as described above with respect to FIG. 2 to provide fairness between the information flow inputs.

In the unallocated segment 312, however, information flow inputs received from at least one of the ingress points targeting the egress point 308 are directed into a virtual output queue 321. From the virtual output queue 321, the information flows are forwarded to the second level arbitration system 304, where they are processed without regard to fairness concerns. High priority flows (e.g., fabric traffic or management traffic) may be directly provided to the second level arbitration system 304 where they are associated with a weight greater than the aggregated weight received from the allocated segment and thus have a higher relative priority than the flows received from the allocated segment. Low priority flows (e.g., background flows) may, for example, be associated with a weight lower than the aggregated weight received from the allocated segment and thus have a lower relative priority than the flows received from the allocated segment. The stage 300 may, for example, comprise a plurality of allocated segments and/or unallocated segments (e.g., a high priority unallocated segment and a low priority unallocated segment). In this example, medium priority information flows comprising the bulk of the traffic (e.g., user data traffic flows) are forwarded through the allocated segment 310 and are have a relative priority lower than the unallocated high priority information flows, and a relative priority higher than the unallocated the low priority information flows.

The information flows (e.g., packets or frames) are received at the ingress points 306 targeting the egress point 308. The information flows comprise at least a destination identifier and other information from which the egress point 308 can be derived. The information flows may further comprise additional fields such as a source identifier and/or a virtual fabric identifier that may be used to assign the information field to one of the allocated virtual input queues 316. The information flows thus may be assigned to the input queues 316 of the allocated segment 310. In addition, one or more of the individual virtual input queues may be individually assignable, e.g., information flows may be directly assigned to a particular virtual input queue instead of merely to the allocated segment. If the information flow does not identify a virtual input queue 316, however, the information flow is transferred to the virtual output queue of the unallocated segment 315. Frames that were not assigned to the allocated segment, however, may be transferred to the unallocated segment and treated with a fixed weight by the arbiter 322. Alternatively, a look up table, such as a content addressable memory (CAM), may be used by the stage to identify a path for an information flow received at an ingress point 306 of the stage 300. If an information flow comprises a destination ID identifying the egress point 308, and the flow is received by the stage at a particular ingress point 306, the look up table may identify a particular virtual input queue 316 or a virtual output queue 321 of the unallocated segment 315. In this example, the path of the information flow is tied to the ingress point 306 it is received at and the egress point 308 it is targeting.

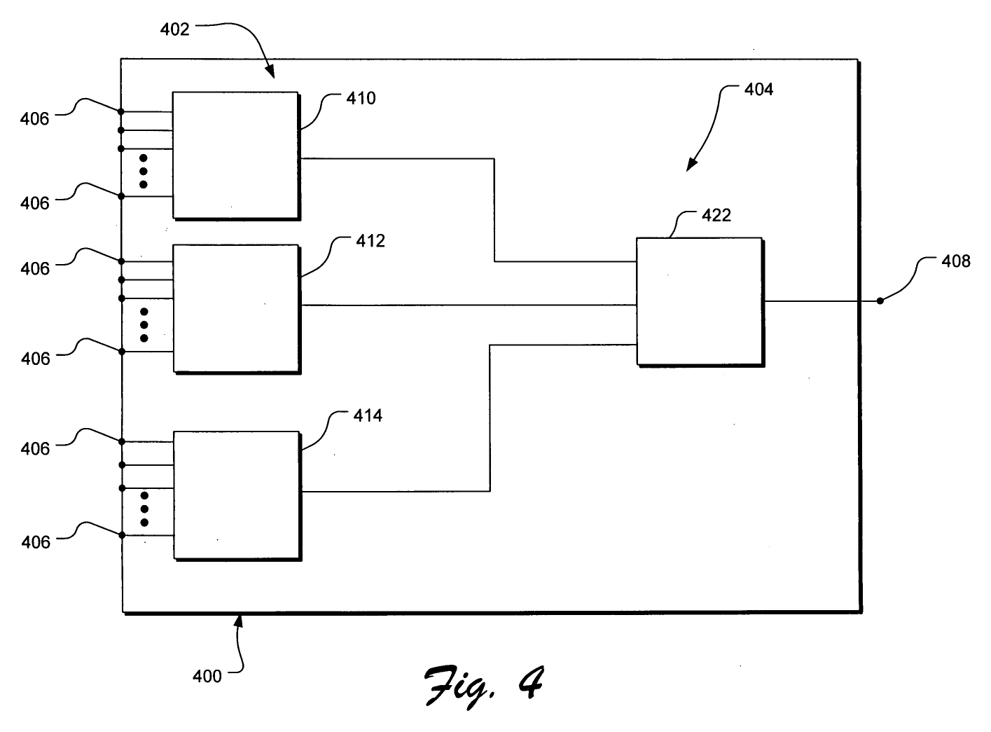

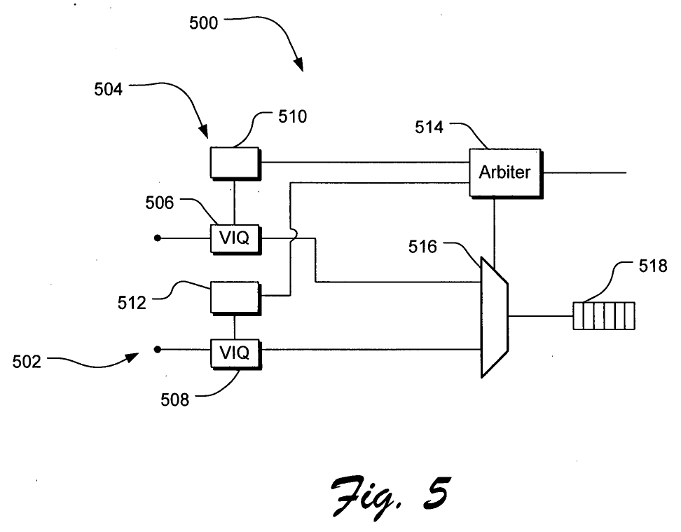

FIG. 4 illustrates an exemplary stage 400, such as a switch network of a SAN. The stage 400 comprises a first level arbitration system 402, a second level arbitration system 404, a plurality of ingress points 406, and at least one egress point 408. The first level arbitration system 402 comprises a plurality of switch segments 410, 412, and 414. The ingress points 406 are coupled to the input ports of the switch segments 410, 412, and 414 of the first level arbitration system 402. The output ports of each of the switch segments 410, 412, and 414 are, in turn, coupled to input ports of a switch 422 of the second level arbitration system 404. An output port of the switch 422 of the second level arbitration system 404 is coupled to the egress point 408 of the stage 400.

The switch segments 410, 412, and 414 receive information flows from the ingress points 406. Each of the ingress points 406 has a weight assigned to it. The switch segments arbitrate between information flows received from active ingress points 406 based on the weights of those ingress points 406. Weights assigned to the active ingress points 406 are aggregated for each of the switch segments 410, 412, and 414 to determine aggregate weights for the output ports of the switch segments 410, 412, and 414. The aggregate weight of each switch segment at a particular point in time is forwarded with information flows passed from the switch segments 410, 412, and 414 to the switch 422 of the second level arbitration system 404. The switch 422 then uses the aggregated weights received with the information flows from the switch segments 410, 412, and 414 of the first level arbitration system 402 to arbitrate between the information flows received from the switch segments 410, 412, and 414 of the first level arbitration system 402 and forwards the selected information flow to the egress point 408 of the stage 400.

Although only two hierarchical levels of the switch system are shown for the stage 400, any additional number of switches may be utilized. In such an example, each level may arbitrate between information flows received from active ingress points based upon weights associated with the information flows and aggregate those weights to determine an aggregated weight for that level. The level forwards a selected information flow along with the aggregate weight determined for that level. The switch of the next level receives information flows from a plurality of upstream switches and their associated aggregate weights and arbitrates between these received information flows based upon the associated aggregate weights. The level also aggregates each received aggregate weight and forwards the newly aggregated weight with a selected information flow to another downstream switch until the switch provides the selected information flow to the egress point of the stage 400.

Although the embodiments shown in FIGS. 2-4 show multiple ingress points and only a single egress point, other embodiments within the scope of the present invention may be utilized in which at least one of the ingress points shown may route information to a plurality of egress points of the stage. Similar to the embodiment shown in FIG. 2, the ingress point would include a first virtual input queue for receiving information flow inputs targeting a first egress point and a second virtual input queue targeting a second egress point. Alternatively, the stage may comprise at least one shared virtual input queue serving multiple ingress points and/or multiple egress points. In addition, where a stage comprises a plurality of egress points, the flow of information flows to at least one of the egress points may be managed, while the flow of information to at least one other egress point may not be managed, such as where congestion is less likely to occur or is less likely to cause significant disruption to an overall system (e.g., where the path in a stage is inherently fair).

FIG. 5 shows an exemplary configuration of a segment 500 that may be used within a hierarchical switch system as described above. The segment 500 comprises a data plane 502 through which data information flows (e.g., data packets or frames) are transmitted and a control plane 504 through which control information related to the data information flows are transmitted out-of-band from the data information flows being transmitted through the data plane 502. In this configuration, data information flows are received by the segment at a first virtual input queue 506 or a second virtual input queue 508 (although any other number of virtual input queues may be used). A weight associated with the virtual input queues 506 and 508 or the data information flows themselves (e.g., extracted from the data information flows or received separately from the data information flows) is determined at a first control block 510 or a second control block 512. The weights are transferred from the first control block 510 and the second control block 512 via the control plane 504 to an arbiter 514, which uses the received weights to control the operation of a multiplexer 516 as described above. The arbiter 514 also forwards an aggregate weight out-of-band via the control plane 504 that is associated with a data information flow that is being transmitted via the data plane 502 to a virtual output queue 518.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of managing fairness in a hierarchical switch system between a plurality of ingress points and a common egress point, the method comprising:
determining an individual weight for at least one input of a first arbiter segment of a stage;
arbitrating the at least one input based upon the individual weight;
determining an aggregate weight of active inputs of the first arbiter segment; and
forwarding the aggregate weight to a second-level arbiter.

2. The method of claim 1, wherein the individual weight is assigned to a virtual input queue of the first arbiter segment.

3. The method of claim 1, wherein the individual weight is associated with the virtual input queue.

4. The method of claim 1, wherein the determining an individual weight operation comprises receiving the individual weight along with the input.

5. The method of claim 1, wherein the arbitrating operation comprises weighted round robin queuing.

6. The method of claim 1, wherein the arbitrating operation comprises biasing a scheduling of the at least one input.

7. The method of claim 1, wherein the arbitrating operation comprises assigning a percentage of available bandwidth based upon the ratio of the individual weight to the aggregate weight.

8. The method of claim 1, wherein the second level arbiter receives at least one allocated inputs and at least one unallocated input.

9. The method of claim 1, wherein the forwarding operation is communicated in-band with a selected information flow of the first arbiter segment.

10. The method of claim 1, wherein the forwarding operation is communicated out-of-band with a selected information flow of the first arbiter segment.

11. A hierarchical switch stage for managing fairness during congestion, the stage comprising:
at least one egress point;
a plurality of ingress points targeting the egress point;
a first level arbiter coupled to at least one of the plurality of ingress points; and
a second level arbiter coupled to the first level arbiter and the egress point,
wherein the first level arbiter comprises a plurality of arbiter segments, each of the arbiter segments adapted to receive information flow inputs from at least one of the ingress points, to arbitrate between the information flows based upon weights associated with the at least one ingress point, to determine an aggregate weight associated with any active ingress points, and to forward the aggregate weight to the second level arbiter, wherein the second level arbiter arbitrates between information flows received from the plurality of arbiter segments of the first level arbiter based upon the aggregate weights received from the plurality of segments.

12. The stage of claim 11, wherein at least one of the plurality of arbiter segments comprises a plurality of virtual input queues.

13. The stage of claim 12, wherein each of the virtual input queues is associated with a weight.

14. The stage of claim 13, wherein at least one of the plurality of arbiter segments further comprises an arbiter that receives information flows from at least one of the plurality of virtual input queues and arbitrates between the information flows based upon the weights associated with the virtual input queues.

15. The stage of claim 14, wherein the at least one of the plurality of arbiter segments further comprises a virtual output queue for receiving selected information flows and for providing the selected information flows to the second level arbiter.

16. The stage of claim 14 further comprising a virtual output queue for receiving information flows from at least one ingress point and providing the information flows to the second level arbiter.

17. The stage of claim 16 wherein the virtual output queue further provides an associated weight to the second level arbiter.

18. The stage of claim 11, wherein the aggregate weight is communicated in-band with the selected one of the information flows to the second level arbiter.

19. The stage of claim 11, wherein the aggregate weight is communicated out-of-band with the selected one of the information flows to the second level arbiter.

20. The stage of claim 11, wherein the stage comprises a fabric of a SAN, and the plurality of ingress points comprises a plurality of input ports of a switch, and the egress point comprises an output port of the switch.

21. A hierarchical switch stage for managing fairness during congestion, the stage comprising:
at least one egress point;
a plurality of ingress points targeting the egress point;
a first level arbiter coupled to at least one of the plurality of ingress points; and
a second level arbiter coupled to the first level arbiter and the egress point,
wherein the first level arbiter comprises a means for arbitrating between a plurality information flows received from at least one of the ingress points based upon weights associated with the information flows, determining an aggregate weight of active ingress points, and forwarding the aggregate weight to the second level arbiter, and wherein the second level arbiter comprises a means for arbitrating between the selected one of the information flows and other information flows based at least in part upon the aggregate weight.
